(19) United States
(12) Patent Application Publication
(10) Pub. No.: US 2011/0250807 A1
(43) Pub. Date: Oct. 13, 2011

(54) FIBER COMPOSITE MATERIALS OF CONSTRUCTION, PARTICULARLY FOR ROOF LINER STRUCTURES

(75) Inventor: Michael KALBE, Weinheim (DE)

(73) Assignee: BASF SE, Ludwigshafen (DE)

(21) Appl. No.: 13/080,879

(22) Filed: Apr. 6, 2011

Related U.S. Application Data
(60) Provisional application No. 61/322,918, filed on Apr. 12, 2010.

(51) Int. Cl. D03D 15/00; B32B 37/00; D04B 21/00; B32B 29/00; B32B 21/10

(52) U.S. Cl. 442/181; 428/532; 442/413; 442/304; 264/257

(57) ABSTRACT

The present invention relates to a fiber composite material of construction, comprising in order (i)-(iii)

(i) a first fiber composite layer;

(ii) a cork layer;

(iii) a second fiber composite layer.

The present invention relates to fiber composite materials of construction, comprising two fiber composite layers and a cork layer therebetween, and to their use as shaped articles, for example for a motor vehicle interior, more particularly for roof liner structures.

Large-area interior trim components for motor vehicles such as roof liners have hitherto been predominantly fabricated from thermoset composites of polyurethane and glass fiber. Such composite materials are produced from a rigid polyurethane foam, impregnated with a polyurethane adhesive based on diphenylmethane diisocyanate (PMDI), and both-sidedly applied glass fiber nonwovens by molding and polymerization in a hot press. The materials used are not unproblematic. Handling PMDI requires provision of and compliance with strict workplace safety measures. Components based on polyurethane foams are virtually impossible to recycle. Similarly, the use of glass fibers risks glass fiber fly and skin irritation and thus requires special occupational hygiene measures. Thermal recovery of materials comprising glass fiber presents problems due to residues from glass slag.

There is accordingly a demand for alternative materials of construction for large-area automotive moldings. It is an object of the present invention to provide such materials of construction. The materials shall be generally recognized as safe by occupational hygienists and be capable of being recycled.

We have found that this object is achieved by a fiber composite material of construction, comprising in order (i)-(iii)
(i) a first fiber composite layer;
(ii) a cork layer;
(iii) a second fiber composite layer.

The fiber composite material of construction comprises two fiber composite layers as outer layers. The fiber composite layers may exclusively comprise synthetic fibers. Preferably, the fiber composite layers comprise natural fibers. Examples of natural fibers which may be present in the fiber composite layers are fibers of cotton, sisal, flax, hemp, linseed fiber and jute.

The fiber composite layers (i) and (iii) are generally present in the form of a textile fabric. Nonwovens (staple fibers or spunbondeds) are particularly suitable, but wovens and knits are also possible. Preference is given to nonwovens of natural fibers, for example nonwovens of cotton and sisal. Their properties approach those of glass fiber nonwovens.

The natural fibers can be present in admixture with synthetic fibers, for example in admixture with fibers of polypropylene, polyethylene, polyester, polyamide or polyacrylonitrile. The proportion of manufactured-polymer fibers can be up to 50% by weight, and preferably it is up to 30% by weight and more preferably up to 10% by weight. In a particularly preferred embodiment there are no synthetic fibers in addition to the natural fibers.

In a further embodiment of the invention, the fiber composite layers comprise exclusively synthetic fibers, for example the abovementioned synthetic fibers, or polyester fibers of PET or PBT.

The nonwovens can be in a mechanically, thermally or chemically prebonded state. Thermally prebonded nonwovens are obtainable for example by concomitant use of synthetic bonding fibers and thermal treatment in a calender.

The nonwovens, wovens and knits are preferably impregnated with a thermally crosslinkable binder. Suitable thermally crosslinkable binders are binders based on crosslinkable polyacrylic acids, acrylic acid-maleic acid copolymers, formaldehyde resins, such as urea-formaldehyde (UF) resins, phenol-formaldehyde (PF) resins, melamine-formaldehyde (MF) resins and melamine-urea-formaldehyde (MUF) resins, crosslinkable aqueous dispersions, such as crosslinkable styrene-butadiene dispersions, styrene-acrylate dispersions and purely acrylate dispersions. Combinations of formaldehyde resins and aqueous dispersions are also possible.

In one embodiment of the invention, thermally crosslinkable binders based on acrylic acid-maleic acid copolymers and triethanolamine as a crosslinker, which are described in EP 0 882 093 B1 for example, are used as binders for the nonwovens, wovens and knits.

The basis weight of the fiber composite layers is generally 400 g/m², preferably <200 g/m² and more preferably <150 g/m². It is more particularly in the range from 100 to 150 g/m² for automotive roof liners.

The middle layer of the fiber composite material of construction is a cork layer (ii). The cork layer consists of binder-bonded cork agglomerates, and can be formed from granular cork of differing particle size. Choosing certain particle sizes makes it possible to achieve specific densities for the cork layer. In general, cork layers having a density of <200 kg/m³ are used. The thickness of the cork layer is generally 4-6 mm, and the basis weight of the cork layer is generally <500 g/m². For automotive roof liners, the basis weight of the overall layered composite formed with the two natural-fiber composite layers (i) and (iii) should be <800 g/m².

The cork layer is prebonded with suitable thermoplastic or thermosetting binders and preferably used in uncured form. As a result, the cork layer is very flexible and easy to mold into shape. Preference is given to the abovementioned thermally crosslinkable binders based on crosslinkable acrylates, acrylate-containing copolymers, crosslinkable aqueous dispersions and also polyurethane systems of the kind also used for impregnating the natural-fiber composite layers.

The present fiber composite materials of construction are produced by thermally molding the layered composite and thermal crosslinking of the binder. A thermally crosslinkable binder is present in the fiber composite layers at least. To this end, the first fiber composite layer, the cork layer and the second fiber composite layer are placed one on top of the other in the uncured state and are three-dimensionally shaped as desired and then thermally crosslinked in a hot press. The curing of fiber composite layers and cork layer takes place in the hot press.

Depending on construction (nonwoven weights, cork density, binder fraction), the mechanical properties can be widely varied and conformed to requirements.

Hence the present fiber composite material of construction meets the relevant specifications.

The fiber composite materials of construction are readily recyclable. No glass slag is generated in thermal recycling.

The present fiber composite materials of construction are useful in the manufacture of large-area articles for the interior of automotive vehicles. Examples are roof liners, parcel shelves and trunk linings. The fiber composite materials of construction can also be used in the manufacture of furniture, for example school furniture. In general, they can be used in the manufacture of shaped articles where the shaping is effected in a hot press. A preferred application is the use of the fiber composite materials of construction, preferably the natural-fiber composite materials of construction comprising fiber composite layers of natural fibers, in the manufacture of roof liners.

### EXAMPLE

A fiber composite material of construction consisting of an Acrodur-bonded cork carrier which is reinforced on both sides with a similarly Acrodur-bonded nonwoven is produced as follows:

### 1. Producing the Cork Carrier

A vessel is initially charged with 206 g of cork having the customary moisture content of 3%. Under agitation, 16 g of Acrodur thermosettable phenol- and formaldehyde-free reactive acrylate resin having a solids content of 50% are added during 2 minutes. The cork to binder ratio thus set is 100:4 (based on the dry components). The moisture content of cork/Acrodur mixture is 6.4%.

A square metallic mold having a format of 15×15 cm, a height of 10 cm and a volume of 2250cm³ is heated to 130° C. in a heatable press during 10 minutes. 216 g of cork-binder mixture are weighed into the mold thus preheated. A perforate lid 7 cm in thickness is used to close the mold such that the contents are compressed down to a thickness of 3 cm. The predetermined volume means that the desired density of 0.24g/cm³ is obtained. The residence time in the hot press at 130° C. is 60 minutes. Following expiration of the pressing time the cork plate is removed from the mold. The 4 mm thick cork carriers needed for the roof liner are subsequently sawn out of the block.

### 2. Impregnating the Cotton-Sisal Outer-Layer Nonwoven

The nonwoven having a basis weight of 100 g/m² is impregnated with Acrodur 950 I. To this end, the Acrodur is diluted to 40% with water and then adjusted to a density of 450 g/cm³ by air being stirred into it. The nonwoven is impregnated with the foam under standard conditions using a laboratory pad-mangle. The binder quantity set is 100 g/m². After impregnation, the nonwovens are dried in a drying cabinet at 70° C. to a residual moisture content of 18%.

### 3. Producing the Roof Liner Components

An assembly of a sawn-out cork disk in a format of 30×30 cm between an Acrodur-bonded nonwoven on each side is compression molded at 200° C. for 60 seconds down to a thickness of 4 mm. Following expiration of the pressing time a dimensionally stable component can be demolded. The density is 0.24 g/cm³ coupled with a basis weight of about 1000 g/m².

The fiber composite material of construction thus obtained is subjected to mechanical testing. The results are summarized in the table below:

| | | |
|---|---|---|
| ISO 179-1/1fU impact strength | kJ/m² | 5 |
| standard deviation | kJ/m² | 1 |
| ISO 178 flexural test | | |
| flexural strength at 23° C. | N/mm² | 4 |
| standard deviation | N/mm² | 1 |
| modulus of elasticity | N/mm² | 438 |
| standard deviation | N/mm² | 39 |

We claim:

1. A fiber composite material of construction, comprising in order (i)-(iii)
(i) a first fiber composite layer;
(ii) a cork layer;
(iii) a second fiber composite layer.

2. The fiber composite material of construction according to claim 1 wherein the first and second fiber composite layers comprise natural fibers.

3. The fiber composite material of construction according to claim 1 or 2 wherein the first and second fiber composite layers comprise natural fibers selected from fibers of cotton, sisal, flax, hemp, linseed fiber and jute.

4. The fiber composite material of construction according to any one of claims 1 to 3 wherein the first and second fiber composite layers comprise a nonwoven, woven or knit of natural fibers.

5. The fiber composite material of construction according to any one of claims 1 to 4 wherein the first and second fiber composite layers in the uncured state comprise a thermally crosslinkable binder.

6. The fiber composite material of construction according to any one of claims 1 to 5 wherein the cork layer in the uncured state comprises a thermally crosslinkable binder.

7. The fiber composite material of construction according to any one of claims 1 to 6 in the form of automotive interior components.

8. A process for producing fiber composite materials of construction according to any one of claims 1 to 6, wherein the first fiber composite layer, the cork layer and the second fiber composite layer are placed one on top of the other in the uncured state and are shaped as desired and thermally crosslinked in a hot press.

9. The use of fiber composite materials of construction according to any one of claims 1 to 7 in the manufacture of roof liners.
